(19) United States
(12) Patent Application Publication
(10) Pub. No.: US 2026/0215368 A1
(43) Pub. Date: Jul. 30, 2026

(54) Apparatus for Raking and Baling Hay

(71) Applicant: Duane GARGAN, Hawera (NZ)

(72) Inventor: Duane GARGAN, Hawera (NZ)

(21) Appl. No.: 19/459,627

(22) Filed: Jan. 26, 2026

(30) Foreign Application Priority Data
Jan. 27, 2025 (NZ) 818158

(51) Int. Cl. A01D 78/10; A01F 15/07

(52) U.S. Cl. CPC A01D 78/1078; A01F 15/07

(57) ABSTRACT

A preferred embodiment of this invention addresses the problem of inefficient hay baling. It involves apparatus for raking and baling hay comprising a vehicle coupling, a rake coupling, a baler coupling, a main drive shaft, a sub-shaft, and a force transfer means. The apparatus being arranged such that the vehicle coupling is adapted for engagement with a towing vehicle (e.g. a tractor) such that force from the vehicle is able to rotationally drive the first shaft. The force transfer means is adapted to transfer rotational force from the first shaft for rotationally driving the sub-shaft. The rake coupling and the baler coupling are adapted to engage a hay rake and hay baler respectively such that the rake and baler can be simultaneously towed by the vehicle so that the rake causes a row of hay to form in front of the baler and the baler gathers and bales the hay.

### FIELD OF THE INVENTION

This invention relates to a towable agricultural apparatus for use in producing hay bales.

### BACKGROUND

Known hay baling methods involve three steps. The first is cutting grass and leaving it on a field to dry. The second step is to form the cut grass into rows for collection. This may be performed with hay rakes towed by a tractor. The third step is to gather the hay from its rows into compact hay bales for easy handling, transport, and storage. As will be appreciated, a baling process as above involves three separate passes over a field, one for each of the above steps. A problem is that this process can be time and cost inefficient.

### OBJECT

It is an object of preferred embodiments of the invention to go at least some way towards addressing the above problem. While this object applies to preferred embodiments, the object of the invention per se is simply to provide the public with a useful choice. Therefore, any objects or advantages applicable to preferred embodiments should not be taken as a limitation on claims expressed more broadly.

### DEFINITIONS

The terms “comprising” and “having”, if and when used in this document in relation to a combination of features, should not be seen as excluding the option of additional unspecified features or steps. In other words, they should not be interpreted in a limiting way.

Orientational terms, for example lateral, upwardly, top, bottom, etc, if and when used in this document, refer to the orientation the associated features will have when in a normal in-use disposition.

### SUMMARY OF INVENTION

According to one aspect, the invention is an apparatus for raking and baling hay, comprising:
a vehicle power coupling;
a rake coupling;
a baler coupling;
a first shaft;
a second shaft; and
a force transfer means (e.g. a pair of pulleys);

arranged such that:
the vehicle coupling is adapted for engagement with a towing vehicle to transfer force from the vehicle to rotationally drive the first shaft;
the first shaft is adapted to power a baler via the baler coupling;
the force transfer means (e.g. the pair of pulleys) is adapted to transfer rotational force from the first shaft to the second shaft to power a hay rake via the rake coupling; and
the apparatus is adapted to move the rake and baler across hay when towed by the vehicle such that the rake causes a row of the hay to form in front of the baler and so that the baler gathers and bales the hay.

Optionally the apparatus comprises a draw bar adapted to hitch to the vehicle to enable the rake and baler to be towed by the vehicle.

Optionally the apparatus is arranged such that the force transfer means comprises a first rotor and a second rotor, the first rotor being connected to the second rotor (e.g. by way of a belt) such that rotation of the first rotor causes rotation of the second rotor.

Optionally the rotors are of different sizes and are arranged so that when in use they rotate at different speeds.

Optionally the second rotor is arranged to cause the second shaft to rotate at a slower speed than the first shaft and wherein the second shaft is adapted to power the rake.

Optionally the first shaft is adapted to power the baler.

Optionally the first shaft is adapted to rotate the first rotor, the first rotor is adapted to drive a belt to rotate the second rotor, the second rotor is adapted to rotate the second shaft such that the second shaft powers the rake.

Optionally the first rotor is smaller than and is adapted to rotate faster than the second rotor.

Optionally each of the first and second rotors comprise a pulley.

Optionally the apparatus further comprises a connector adapted to link the rake and baler for towing, the connector having a pivot connection for articulating the baler with respect to the rake, the connector also comprising a hydraulic ram adapted to drive articulating movement between the tractor and rake.

Optionally the apparatus comprises a safety bar adapted to releasably lock the connector to prevent articulation between the baler and rake.

Optionally the rake coupling is engaged with the rake, the baler coupling is engaged with the baler and the vehicle coupling is engaged with the towing vehicle.

Optionally the apparatus is towed by the vehicle such that the rake rakes hay and the baler bales the hay.

Optionally the first shaft is telescoping such that it is length adjustable.

Optionally the apparatus has one or more hay distributors arranged between the rake and baler such that when in use they distribute hay evenly across the face of the baler before that hay enters the baler.

Optionally each hay distributor comprises a panel.

Optionally each hay distributor is angle adjustable to enable more or less hay to be moved into position across the face of the baler.

According to a further aspect, the invention is an apparatus for raking and baling hay comprising:

a vehicle coupling;

a rake coupling;and

a baler coupling;

arranged such that:

the vehicle coupling is adapted for engagement with a towing vehicle to transfer force from the vehicle to power the rake and baler via the rake and baler couplings respectively;and

the apparatus is adapted to move the rake and baler across hay when towed by the vehicle such that the rake causes a row of the hay to form in front of the baler and so that the baler gathers and bales the hay.

The apparatus of this further aspect may incorporate any one of more of the options itemised above for the first mentioned aspect.

### DRAWINGS

Some preferred embodiments of the invention will now be described by way of example and with reference to the accompanying drawings, of which:

FIG. 1 is an isometric view of a tractor towing a hay processor;

FIG. 2 is a side view of the tractor and the processor;

FIG. 3 is a side view illustrating a hitch connection between the processor and a baler;

FIG. 4 is a plan view of a pivoting connector that can be optionally used between rakes and a baler forming part of the processor;

FIG. 5 is a top plan view of a pair of panels that can optionally be used between the rakes and baler; and

FIG. 6 is a side view of the optional panels.

### DETAILED DESCRIPTION

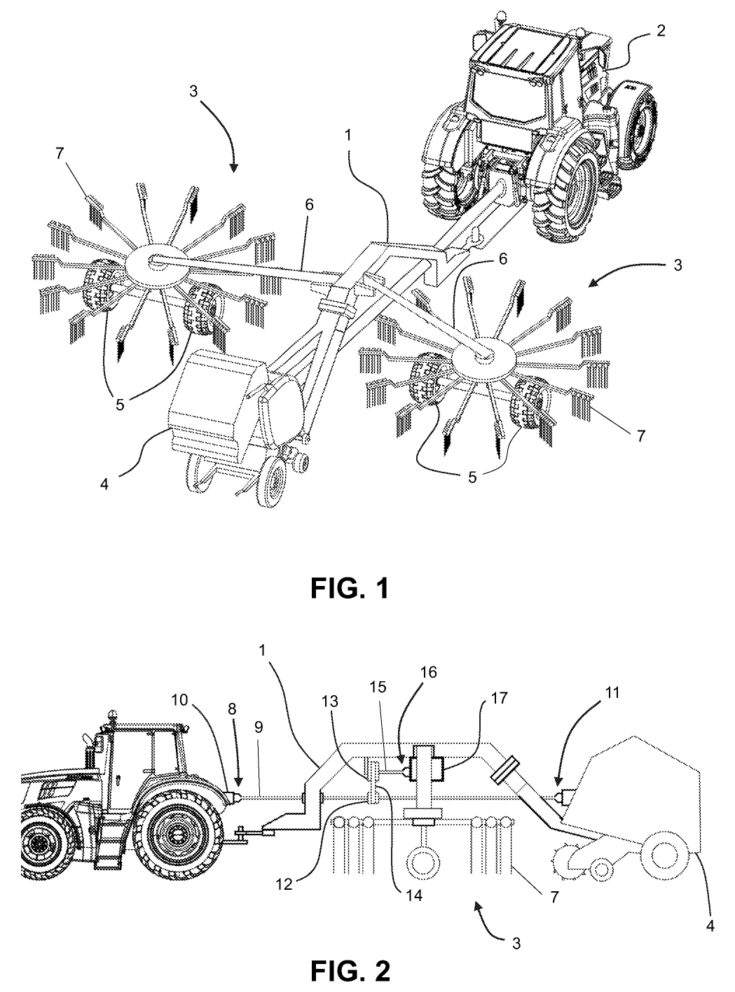

Referring to FIG. 1, the hay processer comprises a draw bar 1 adapted to be hitched to a tractor 2. The draw bar 1 is also hitched to a pair of rakes 3 and a baler 4 which may or may not be considered part of the processor. In either case, the arrangement is such that the tractor is, via the draw bar 1, able to tow the rakes 3 and the baler 4. As also shown, the rake is fitted with a pair of wheels 5 which assist with spreading weight as the tractor tows it.

Still with FIG. 1, each rake 3 comprises a support arm 6 cantilevered from a medial part of the draw bar 1 to support a set of rotating forks 7. The rakes 3 therefore extend outwards at either side of the draw bar 1.

The hay processor is such that when it is towed across a paddock of cut dried grass (hay) the forks 7 rotate to cause a line of hay (not shown) to be formed between the tractor the and the baler 4. As the processor advances, the baler 4 takes up the hay and forms it into bales (not shown).

FIG. 2, illustrates detail of the way power is taken from the tractor to drive the rakes 3 and the baler 4.

Firstly, the hay processor has a power coupling 8 at the forward end of a main drive shaft 9. The coupling 8 and drive shaft 9 may or may not be integral. The coupling 8 engages the power system 10 of the tractor. The arrangement is such that power from the tractor causes the coupling 8 and the shaft 9 to rotate. In some embodiments the coupling 8 may be a standard power take-off U-joint.

A rear end of the drive shaft 9 extends to a baler coupling 11, which serves to transfer rotational force from the shaft 9 to the baler 4. This powers the baler 4 for baling hay. The coupling 11 may or may not be integral with the shaft 9. In some embodiments the coupling 13 may be a standard power take-off U-joint.

Still with FIG. 2, a medial part of the drive main shaft 9 connects to a small pulley 12, which is in turn linked to a large pulley 13 by way of a belt 14. The large pulley 13 is connected to a sub-shaft 15 which is in turn connected to a rake coupling 16.

Preferably the rake coupling 16 is functionally engaged with a three-way gear box 17 forming part of the rake. The coupling 16 may or may not be integral with the sub-shaft. In some embodiments the coupling 16 may be a standard power take-off U-joint.

In the embodiment shown the main drive shaft 9 is in two lengths, each engaging with an opposite end of the small pulley 12, but in other embodiments it may be in one length.

In either case the arrangement is such that power from the tractor transfers to the main drive shaft 9 via the power coupling 8 to cause rotation of the shaft 9, the small pulley 12 and the belt 14. This in turn transfers force to the large pulley 13 to rotate the sub-shaft 15. The rotating sub-shaft 15 brings force to the rake coupling 16 which transfers to the rakes 3 to rotate the sets of forks 7.

Because there are small and large pulleys, there is a slow-down in the rate of rotation between the main drive shaft 9 and the sub-shaft 15. This enables the appropriate degree of rotational movement to be delivered to the rakes and the baler via the vehicle coupling.

It should be appreciated that the power coupling 8 does not hitch the draw bar to the tractor, it is rather a component that transfers rotational force from the tractor to the main drive shaft 9. Similarly, the baler coupling 11 does not hitch the baler to the draw bar, it is rather a component that transfers rotational force from the main drive shaft 9 to the baler. And in like fashion, the rake coupling 16 does not hitch the rakes to the draw bar, it is rather a component that transfers rotational force from the sub-shaft 15 to the rakes. However, in alternative embodiments of the invention one or more of the vehicle, baler and rake couplings may be incorporated into components that also have a hitching function.

As illustrated, the draw bar 1 has a raised mid-section to accommodate the shafts 9, 15 and the pulleys 12, 13. The draw bar 1 further comprises a tow eye which attaches to the tractor via a pin.

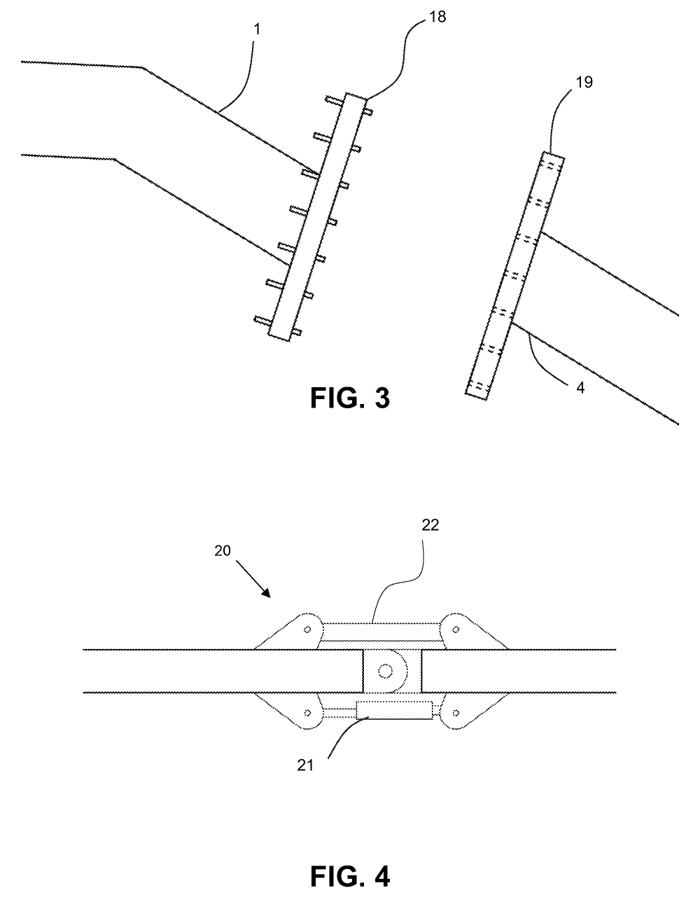

FIG. 3 illustrates detail of the way in which the baler is hitched to the drawbar. In this regard a connector plate 18 of the draw bar is bolted to a connector plate 19 of the baler. The draw bar’s connector plate 18 has a large number of bolt holes so that it can accommodate a wide range of baler connector plates, for example in case the processor is used with a range of balers each at a different time.

Referring to FIG. 4, in some embodiments, to enable the apparatus to negotiate corners it incorporates a connector 20 between the tractor 2 (not shown) and the rake 3 (not shown) or at some other position of the drawbar. The connector 20 pivots in a similar manner of a normal ball joint trailer hitch. The pivoting is preferably driven or enhanced by a hydraulic ram 21. To prevent undesired pivoting when for example the apparatus is being towed on a road at speed, a rigid safety bar 22 can be rigidly secured either side of the coupling’s pivot point to lock it against pivoting. The bar can also be left in place in some raking-baling operations where the apparatus does not need to negotiate tight turns. Optionally the drive shaft 9 is telescoping so as to be length adjustable to accommodate pivoting at the connector. This enables the drive shaft 9 to run in a straight line while drawbar pivoting occurs at the connector 20.

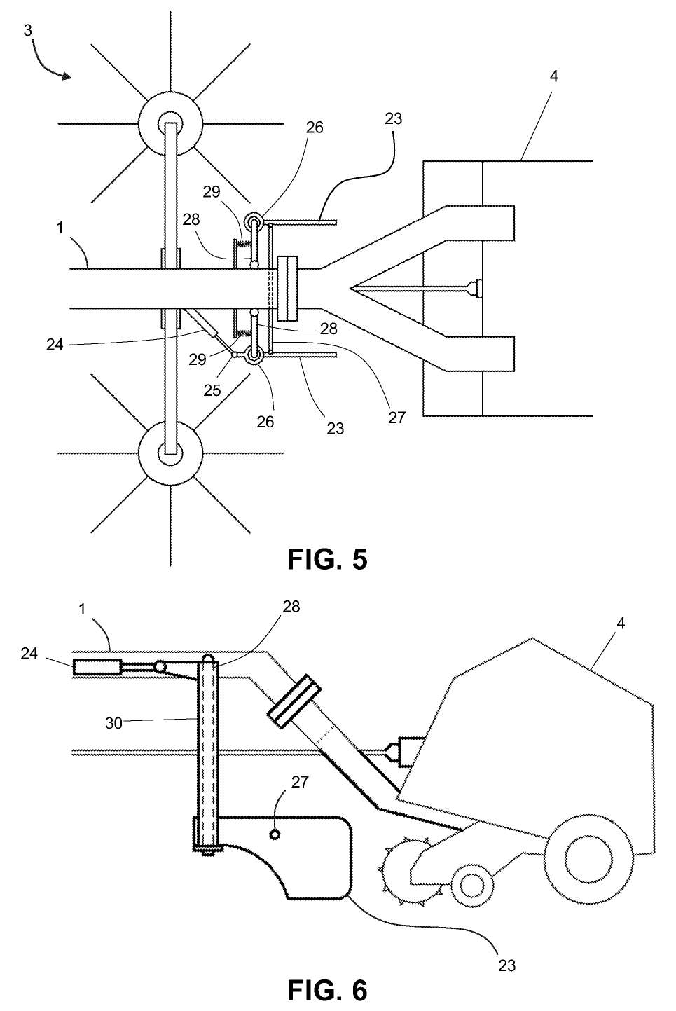

Referring to FIGS. 5 and 6, in some embodiments as above, the hay processor may have a pair of panels 23 spaced and elevated slightly above ground level between the rake 3 and baler 4. These provide a channel for directing raked hay to the baler in a more even manner. If for example the hay on the ground is bunched more to one side of the baler, then one or other of the panels 23 can move it across so that the hay feeds into the baler in a generally uniform manner across the face of the baler.

Preferably the panels 23 can be moved in unison or separately. In this regard they can be moved manually or by a motor or hydraulics such that they can be positioned where needed, ie depending on where the hay is sitting on the ground in front of the baler 4. In some cases only one of the panels may be angled or otherwise moved with respect to the draw bar, or one panel moved a different amount to the other, if for example there is more hay the ground at one side or the other of the face of the baler.

In some embodiments the panels 23 may be approximately 1 m long and 0.6 m high. Preferably they are supported by wing-like beam structures extending either side of the longitudinal axis of the drawbar 1. In such embodiments the beams may be moveable by an electric motor to locate the panels where desired.

In the example shown in FIGS. 5 and 6, movement of the panels 23 is achieved by extension and contraction of a ram 24. For example, when the ram extends, force is transferred to a first of the panels 23 (the lower one in FIG. 4) via a first pivot connection 25, this causes the panel to pivot about a second pivot connection 26 this turning force is transmitted to the other panel 23 (the upper one in the drawing) via a tie rod 27. In this regard, the tie rod is pivotally connected at one end to the first panel and pivotally connected at its opposite end to the other panel. This enables the second panel to pivot about a pivot connection 26.

As shown in FIG. 5, each of the panels 23 are connected to the drawbar via a support arm 28. The support arms 28 are pivotably connected to the drawbar thus enabling greater movement of the panels for ease of traversal over uneven ground. In this regard, a spring 29 is positioned in front of each support arm 28 to push them back into the correct position after moving about from their environment.

Turning now to FIG. 6, each support arm 28 is L-shaped (extending horizontally away from the drawbar 1 and then vertically down towards a corresponding panel 23). The downward portion of each support arm fits inside a sleeve 30 attached a corresponding one of the panels 23. The support arm is free to rotate within the sleeve thereby enabling pivoting at 26.

As will be appreciated, the above embodiments enable hay to be raked and baled in one pass over a paddock of cut and dried grass. It avoids the need for different passes by rake and baler machinery and enables baling to occur immediately after raking so that raked rows do not sit around exposed to the wind and like, which can cause the rows to be undesirably dispersed. It also avoids rows that have already been raked being run over and compressed or otherwise deformed by a tractor towing a baler doing its work.

While some preferred embodiments of the invention have been described by way of example it should be appreciated that modifications and improvements can occur without departing from the scope of the following claims.

In terms of disclosure, this document hereby discloses each item, feature or step mentioned herein in combination with one or more of any of the other item, feature or step disclosed herein, in each case regardless of whether such combination is claimed.

1. Apparatus for raking and baling hay comprising:
a vehicle power coupling;
a rake coupling;
a baler coupling;
a first shaft;
a second shaft; and
a force transfer means;
arranged such that:
the vehicle coupling is adapted for engagement with a towing vehicle to transfer force from the vehicle to rotationally drive the first shaft;
the first shaft is adapted to power a baler via the baler coupling;
the force transfer means is adapted to transfer rotational force from the first shaft to the second shaft to power a hay rake via the rake coupling; and
the apparatus is adapted to move the rake and baler across hay when towed by the vehicle such that the rake causes a row of the hay to form in front of the baler and so that the baler gathers and bales the hay.

2. Apparatus according to claim 1, comprising a draw bar adapted to hitch to a towing vehicle to enable the rake and baler to be towed by the vehicle.

3. Apparatus according to claim 1, arranged such that the force transfer means comprises a first rotor and a second rotor, the first rotor being connected to the second rotor such that rotation of the first rotor causes rotation of the second rotor.

4. Apparatus according to claim 3, wherein the rotors are of different sizes and are arranged so that when in use they rotate at different speeds.

5. Apparatus according to claim 3, wherein the second rotor is arranged to cause the second shaft to rotate at a slower speed than the first shaft and wherein the second shaft is adapted to power the rake.

6. Apparatus according to claim 3, wherein the first shaft is adapted to power the baler.

7. Apparatus according to claim 3, wherein the first shaft is adapted to rotate the first rotor, the first rotor is adapted to drive a belt to rotate the second rotor, and the second rotor is adapted to rotate the second shaft such that the second shaft powers the rake.

8. Apparatus according to claim 3, wherein the first rotor is smaller than and is adapted to rotate faster than the second rotor.

9. Apparatus according to claim 3, wherein each of the first and second rotors comprise a pulley.

10. Apparatus according to claim 1, comprising a connector adapted to link the rake and baler for towing, the connector having a pivot connection for articulating the baler with respect to the rake, the connector also comprising a hydraulic ram adapted to drive articulating movement between the tractor and rake.

11. Apparatus according to claim 10, comprising a safety bar adapted to releasably lock the connector to prevent articulation between the baler and rake.

12. Apparatus according to claim 1 wherein the rake coupling is engaged with the rake, the baler coupling is engaged with the baler and the vehicle coupling is engaged with the towing vehicle.

13. Apparatus according to claim 12, when towed by the vehicle such that the rake rakes hay and the baler bales the hay.

14. Apparatus according to claim 1, wherein:
a) the apparatus has a draw bar that is hitched to the vehicle to enable the rake and baler to be towed by the vehicle;
b) the force transfer means comprises a first pulley and a second pulley, the first pulley being connected to the second pulley by way of a belt such that rotation of the first pulley causes rotation of the second pulley;
c) the pulleys are of different sizes and are such that when one is caused to be rotated they rotate at different speeds;
d) the second rotor is arranged to cause the second shaft to rotate at a slower speed than the first shaft and wherein the second shaft is adapted to power the rake;
e) the first shaft is adapted to power the baler; and
f) the first shaft is adapted to rotate the first pulley, the first pulley is adapted to drive a belt to rotate the second pulley, and the second pulley is adapted to rotate the second shaft such that the second shaft powers the rake.

15. The apparatus of claim 14, when towed by the vehicle such that the rake rakes hay and the baler bales the hay.

16. Apparatus according to claim 1, wherein the first shaft is telescoping such that it is length adjustable.

17. Apparatus according to claim 1, comprising one or more hay distributors arranged between the rake and baler such that when in use they distribute hay evenly across the face of the baler before that hay enters the baler.

18. Apparatus according to claim 17, wherein each hay distributor comprises a panel.

19. Apparatus according to claim 17, wherein each hay distributor is angle adjustable to enable more or less hay to be moved into position across the face of the baler.

20. Apparatus according to claim 1:
a) comprising a draw bar adapted to hitch to the vehicle to enable the rake and baler to be towed by the vehicle;
b) formed such that the force transfer means comprises a first rotor and a second rotor, the first rotor being connected to the second rotor such that rotation of the first rotor causes rotation of the second rotor;
c) formed such that the rotors are of different sizes and are arranged so that when in use they rotate at different speeds;
d) formed such that second rotor is arranged to cause the second shaft to rotate at a slower speed than the first shaft and wherein the second shaft is adapted to power the rake;
f) formed such that the first shaft is adapted to rotate the first rotor, the first rotor is adapted to drive a belt to rotate the second rotor, and the second rotor is adapted to rotate the second shaft such that the second shaft powers the rake;
g) formed such that the first rotor is smaller than and is adapted to rotate faster than the second rotor.
h) formed such that each of the first and second rotors comprise a pulley;
i) comprising a connector adapted to link the rake and baler for towing, the connector having a pivot connection for articulating the baler with respect to the rake, the connector also comprising a hydraulic ram adapted to drive articulating movement between the tractor and rake;
j) formed such that the rake coupling is engaged with the rake, the baler coupling is engaged with the baler and the vehicle coupling is engaged with the towing vehicle.
